(19) United States
(12) Patent Application Publication
(10) Pub. No.: US 2025/0291750 A1
(43) Pub. Date: Sep. 18, 2025

(54) APPARATUS AND METHODS FOR MONITORING SYSTEM STATUS THROUGH A D-SUB CONNECTOR

(71) Applicant: Aivres Systems Inc., San Jose, CA (US)

(72) Inventor: Sheng Sung CHIU, New Taipei City (TW)

(21) Appl. No.: 19/223,952

(22) Filed: May 30, 2025

(51) Int. Cl. G06F 13/20; G06F 13/42

(52) U.S. Cl. CPC G06F 13/20; G06F 13/4282; G06F 2213/0016; G06F 2213/40

(57) ABSTRACT

Systems, devices, and methods for monitoring system status are described. In one aspect, a monitoring device includes a D-sub connector and an input/output (I/O) expansion circuit. The D-sub connector includes a plurality of terminals, and the plurality of terminals include a first terminal operable as a clock terminal and a second terminal operable as a data terminal. The I/O expansion circuit includes a communication interface, and the communication interface includes a first signal line and a second signal line. The first terminal of the D-sub connector is coupled to the first signal line of the I/O expansion circuit, and the second terminal of the D-sub connector is coupled to the second signal line of the I/O expansion circuit.

### TECHNICAL FIELD

The present disclosure generally relates to apparatus and methods for monitoring system status, particularly through a D-Sub connector interface in electronic hardware architectures.

### BACKGROUND

In many electronic systems, particularly those used in server or computing environments, monitoring tools are used to assess the status of hardware components during maintenance, development, or regular operation. These tools often rely on embedded management controllers to collect and report information related to critical subsystems such as processors, memory modules, power supplies, storage devices, and communication interfaces. Monitoring capabilities may include voltage levels, thermal conditions, and component presence, providing a comprehensive overview of the system's health and aiding in early detection of potential issues.

### SUMMARY

The present disclosure describes methods and systems for monitoring system status.

In a general aspect, a monitoring device includes a D-sub connector and an input/output (I/O) expansion circuit. The D-sub connector includes a plurality of terminals, and the plurality of terminals include a first terminal operable as a clock terminal and a second terminal operable as a data terminal. The I/O expansion circuit includes a communication interface, and the communication interface includes a first signal line and a second signal line. The first terminal of the D-sub connector is coupled to the first signal line of the I/O expansion circuit, and the second terminal of the D-sub connector is coupled to the second signal line of the I/O expansion circuit.

Particular implementations may include one or more of the following features.

In some implementations, the D-sub connector is a Video Graphics Array (VGA) connector.

In some implementations, the communication interface is an inter-integrated circuit (I2C) communication interface.

In some implementations, the first signal line of the communication interface is a clock line, and the second signal line of the communication interface is a data line.

In some implementations, the D-sub connector further includes a third terminal, the I/O expansion circuit further includes a power terminal, and the third terminal of the D-sub connector is coupled to the power terminal of the I/O expansion circuit.

In some implementations, the I/O expansion circuit further includes a plurality of I/O terminals.

In some implementations, the plurality of I/O terminals are General Purpose Input/Output (GPIO) terminals.

In some implementations, at least one I/O terminal of the plurality of I/O terminals is coupled to an indicator operable to provide an indication based on a signal present at the at least one I/O terminal.

In some implementations, the indicator includes a light-emitting element.

In another aspect, a system includes a server and a monitoring device. The server includes a first D-sub connector. The monitoring device includes a second D-sub connector and an I/O expansion circuit. The second D-sub connector is operable to be coupled to the first D-sub connector of the server. The second D-sub connector includes a plurality of terminals, and the plurality of terminals include a first terminal operable as a clock terminal and a second terminal operable as a data terminal. The I/O expansion circuit includes a communication interface, and the communication interface includes a first signal line and a second signal line. The first terminal of the second D-sub connector is coupled to the first signal line of the I/O expansion circuit, and the second terminal of the second D-sub connector is coupled to the second signal line of the I/O expansion circuit.

Particular implementations may include one or more of the following features.

In some implementations, the first D-sub connector of the server includes a first terminal operable as a clock terminal and a second terminal operable as a data terminal.

In some implementations, the server further includes a system management controller, and the system management controller includes a communication interface including a clock line coupled to the first terminal of the first D-sub connector and a data line coupled to the second terminal of the first D-sub connector.

In some implementations, the first terminal of the first D-sub connector is operable to be coupled to the first terminal of the second D-sub connector, and the second terminal of the first D-sub connector is operable to be coupled to the second terminal of the second D-sub connector.

In some implementations, each of the first D-sub connector and the second D-sub connector is a VGA connector.

In some implementations, the communication interface is an inter-integrated circuit (I2C) communication interface.

In some implementations, the I/O expansion circuit further includes a plurality of I/O terminals.

In some implementations, the plurality of I/O terminals are GPIO terminals.

In some implementations, at least one I/O terminal of the plurality of I/O terminals is coupled to an indicator operable to provide an indication based on a signal present at the at least one I/O terminal.

In some implementations, the indicator includes a light-emitting element.

In yet another aspect, a monitoring device includes a D-sub connector and an I/O expansion circuit. The D-sub connector includes a plurality of terminals, and the plurality of terminals include a first terminal operable as a clock terminal and a second terminal operable as a data terminal. The I/O expansion circuit includes a communication interface, and the communication interface includes a first signal line and a second signal line. The first terminal of the D-sub connector is coupled to the first signal line of the I/O expansion circuit, and the second terminal of the D-sub connector is coupled to the second signal line of the I/O expansion circuit. The I/O expansion circuit further includes a plurality of I/O terminals, and each of the plurality of I/O terminal is coupled to an indicator operable to provide an indication based on a signal present at the corresponding I/O terminal.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B illustrate an example D-sub connector, in accordance with one or more implementations of the present disclosure.

FIG. 2 illustrates an example monitoring device, in accordance with one or more implementations of the present disclosure.

FIG. 3 illustrates an example system that includes a server and a monitoring device, in accordance with one or more implementations of the present disclosure.

FIG. 4 illustrates an example computer system, in accordance with one or more implementations of the present disclosure.

FIG. 5 is a flowchart illustrating an example method, in accordance with one or more implementations of the present disclosure.

Like reference numbers and designations in the various drawings indicate like elements.

### DETAILED DESCRIPTION

In server systems undergoing maintenance, development, or diagnostic evaluation, system status is commonly monitored through a baseboard management controller (BMC). The BMC is configured to collect and report the operational state of various hardware components, including processors, memory modules, power supplies, storage devices, and Peripheral Component Interconnect Express (PCIe) expansion cards. The BMC may also provide telemetry data such as voltage levels, temperature readings, and fan speeds. While remote monitoring capabilities enable centralized system management, manual verification methods—such as opening the chassis and inspecting hardware indicators—are often used to validate component presence or troubleshoot system conditions at the board level.

Some server systems utilize internal diagnostic interface cards equipped with small liquid crystal display (LCD) panels to support on-site status reporting. These panels may display values such as temperature or fan speed using data received via an inter-integrated circuit (I2C) interface. In some implementations, a Universal Serial Bus (USB) 3.0 connector is physically used for this connection, while internally, the USB 3.0 TX/RX pins are reassigned to transmit I2C signals. As a result, although the connector form factor suggests USB 3.0 support, the electrical characteristics correspond only to USB 2.0 functionality. This discrepancy may cause user confusion or incorrect assumptions regarding the interface's data throughput and supported features.

Additionally, the display area of such diagnostic panels can be limited, requiring system information to be presented in alternating sequences. For example, temperature and fan speed may be displayed in timed intervals. This configuration can limit the operator's ability to obtain a real-time, comprehensive view of the system state, potentially affecting efficiency during diagnostic or validation procedures.

There is a need for a diagnostic solution that enables immediate access to key system status indicators without requiring substantial modification of standard USB or video interfaces, specialized software configuration, or invasive hardware changes. Such a solution should support rapid deployment, minimal setup, and compatibility with existing server hardware and mechanical enclosures.

Some implementations described herein provide a hardware architecture that includes a compact diagnostic card interfacing with a computing system through a D-sub connector, such as a VGA-compatible interface. The diagnostic card includes an input/output (I/O) expander that communicates with the system's BMC via an I2C connection. Using this communication path, the BMC can control multiple output indicators—such as light-emitting diodes (LEDs)—to visually represent system parameters. The card can be used during system maintenance, development, or manufacturing to verify power rail presence, component installation, or controller activity without opening the chassis.

In many server configurations, a front panel includes a VGA connector electrically coupled to the motherboard via internal cabling. In some implementations, reserved or underutilized pins on the VGA connector—such as pin 4 and pin 11—are reassigned to carry the I2C clock and data signals, respectively. The diagnostic card, inserted into the VGA port, can include a general-purpose I/O expander (e.g., a 16-bit expander) that receives these I2C signals and drives multiple indicator LEDs. Each I/O pin can be connected to a transistor, such as a metal-oxide-semiconductor field-effect transistor (MOSFET), that switches power to a corresponding LED, providing a clear visual indication based on the system signal state.

This approach avoids reliance on USB connectors repurposed for I2C communication, thereby reducing potential misinterpretation related to USB signal expectations. The use of the VGA interface further enables compatibility with server designs that already incorporate such ports for video output or auxiliary connectivity. In some implementations, the VGA connector's 5V supply line is used to power the diagnostic card, eliminating the need for external power sources or cables.

The architecture supports flexible configuration. For example, while a 16-bit I/O expander may support monitoring of 16 system signals, some implementations may employ higher-capacity I/O expanders (e.g., 24-bit or 32-bit) to monitor additional parameters. The monitored signals may include standby and active power rail presence—such as the 12-volt standby power rail, the 5-volt standby power rail, and the 3.3-volt power rail—component presence indicators (e.g., Central Processing Unit (CPU) or fan presence), and control signal activity (e.g., BMC or chipset heartbeat).

This diagnostic approach provides a plug-in hardware tool for visually monitoring system conditions without requiring internal system access. By utilizing reserved pins on a standard connector and reusing existing infrastructure, the solution supports integration with a variety of server platforms while maintaining a non-invasive, low-complexity profile suitable for lab testing, field service, and production environments.

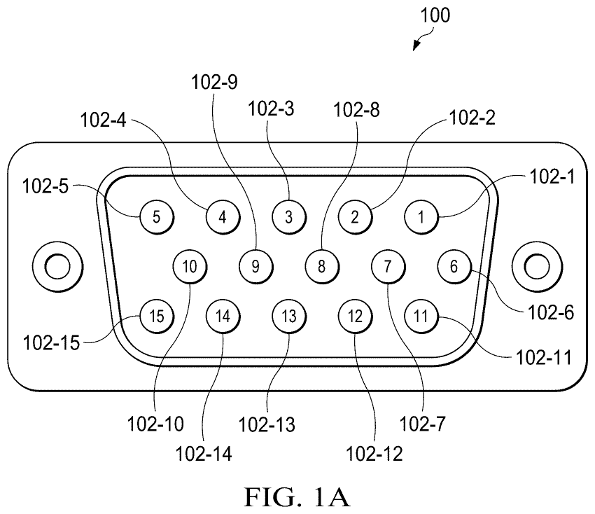

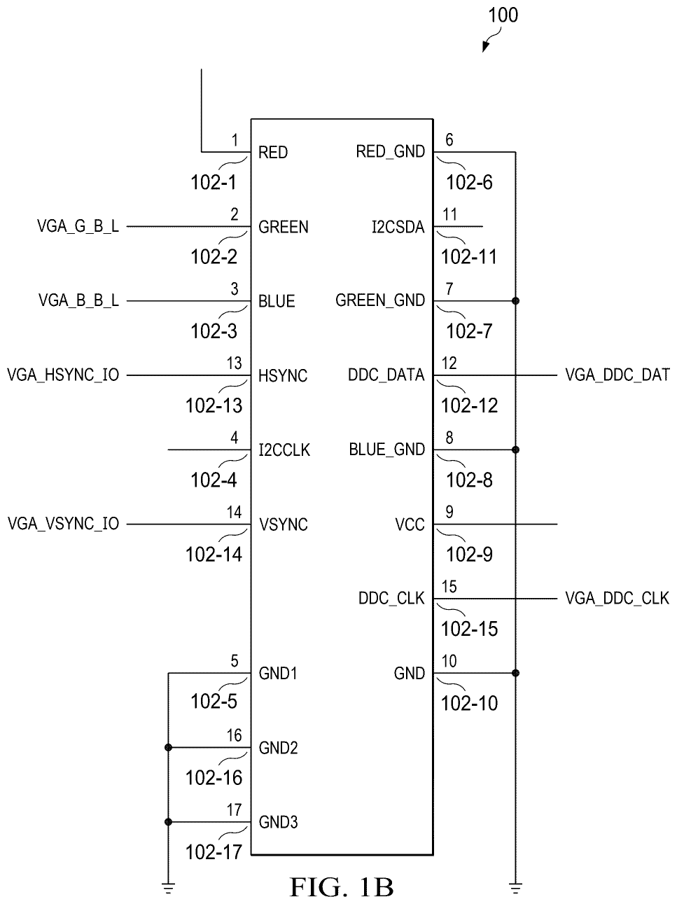

FIGS. 1A and 1B illustrate an example D-sub connector 100, which is implemented as a Video Graphics Array (VGA) connector, in accordance with one or more implementations of the present disclosure.

In general, a D-sub connector can be used to facilitate electrical communication between components within an electronic system. A D-sub connector, also referred to as a D-subminiature connector, includes two or more parallel rows of electrical terminals (e.g., pins or sockets) enclosed within a D-shaped metal shell. The shell provides mechanical support, ensures proper orientation during mating, and may serve as a shield to reduce electromagnetic interference (EMI).

In some implementations, D-sub connectors are gendered. A D-sub connector that includes pin contacts is referred to as a male connector (or plug), while a D-sub connector that includes socket contacts is referred to as a female connector (or receptacle). During engagement, the shell of the female D-sub connector is designed to fit within the shell of the male D-sub connector, thereby establishing proper mechanical and electrical contact, as well as grounding continuity.

D-sub connectors can be used for a variety of purposes, including analog video transmission (e.g., VGA), serial communication (e.g., RS-232), and general-purpose control signaling. In some configurations, panel-mounted D-sub connectors include threaded standoffs or jackscrews to secure a mating cable and provide strain relief.

In some implementations, certain terminals on the D-sub connector 100 that are unused or reserved are repurposed to carry low-speed auxiliary signals, such as Inter-Integrated Circuit (I2C) signals, allowing for additional functionality without altering the form factor of the connector. For example, I2C signals generated by a system's BMC may be routed through reserved pins to interface with external devices or diagnostic modules.

In some implementations, the D-sub connector 100 illustrated in FIG. 1A conforms to the VGA standard. In such cases, the connector 100 adopts the DE-15 configuration, including fifteen electrical terminals 102-1 through 102-15 arranged in three parallel rows within an E-size D-sub shell. The terminals 102-1 through 102-15 can be configured to carry analog video signals, ground references, power supply lines, and potentially other auxiliary signals depending on system requirements. The arrangement and signal assignments of terminals 102-1 through 102-15 generally conform to the VGA standard. However, in some implementations, certain terminals of the D-sub connector 100 are repurposed to support additional functionality related to system diagnostics. For example, terminal 102-4 can be repurposed to transmit an auxiliary signal, such as an I2C clock signal, while terminal 102-11 can be repurposed to transmit an I2C data signal. This allows for direct communication between the system's BMC and an external diagnostic module via the existing VGA interface.

Table 1 illustrates an example signal assignment of terminals 102-1 through 102-15, including the repurposed terminals 102-4 and 102-11, which are assigned to transmit auxiliary signals—specifically, an I2C clock signal and data signal, respectively.

TABLE 1

| Terminal | Signal name | Description of the function |
|---|---|---|
| 102-1 | Red | Red video signal |
| 102-2 | Green | Green video signal |
| 102-3 | Blue | Blue video signal |
| 102-4 | I2CCLK | I2C clock signal |
| 102-5 | GND | Ground |
| 102-6 | Red GND | Red signal ground |
| 102-7 | Green GND | Green signal ground |
| 102-8 | Blue GND | Blue signal ground |
| 102-9 | +5 V (DDC Power) | Display Data Channel (DDC) power |
| 102-10 | Sync GND | Synchronization signal ground |
| 102-11 | I2CSDA | I2C data signal |
| 102-12 | DDC Data | DDC data communication |
| 102-13 | H-Sync | Horizontal synchronization signal |
| 102-14 | V-Sync | Vertical synchronization signal |
| 102-15 | DDC Clock | DDC clock signal |

FIG. 1B illustrates an example configuration and signal assignment of terminals 102-1 through 102-15, as well as two additional terminals, 102-16 and 102-17, which are grounded. The additional terminals 102-16 and 102-17 are not shown in FIG. 1A but are included in FIG. 1B to reflect internal grounding structures that may be present in certain implementations.

In some examples, terminal 102-1 can be configured to carry the red video signal, while terminal 102-2 can carry the green video signal, and terminal 102-3 can carry the blue video signal. Terminal 102-4 can be repurposed to carry an auxiliary signal, such as an I2C clock signal. Terminal 102-5 can function as a digital ground, providing a return path for video or communication signals. Terminals 102-6, 102-7, and 102-8 can serve as dedicated ground lines for the red, green, and blue video channels, respectively. Terminal 102-9 can provide a DC power supply (such as 5V DC power supply), which can be used to power an external module connected to the VGA interface. Terminal 102-10 can serve as a ground for synchronization or other control signals. Terminal 102-11 can be repurposed for an I2C data signal. Terminal 102-12 can carry display identification or data communication signals, such as Display Data Channel (DDC). Terminals 102-13 and 102-14 can be configured to carry horizontal and vertical synchronization signals, respectively. Terminal 102-15 can be reserved or designated for manufacturer-specific or future-defined functions.

Terminals 102-16 and 102-17, as shown in FIG. 1B, can be internally connected to ground and serve to enhance electrical grounding and shielding performance. These additional terminals may not be externally accessible but may contribute to overall signal integrity and electromagnetic compatibility in the connector system.

In some implementations, the power available through terminal 102-9 is utilized to supply power to an external diagnostic card connected to the D-sub connector 100. This allows the diagnostic card to operate without the need for separate power adapters or USB-based connections. As a result, the configuration enables convenient plug-and-play functionality, simplifying deployment and reducing hardware complexity.

Accordingly, the D-sub connector 100 can serve not only as a conventional video output interface, but also as a multifunctional diagnostic port capable of supporting enhanced system monitoring capabilities. By leveraging both the repurposed signal terminals—such as terminals 102-4 and 102-11 for I2C communication—and the power availability at terminal 102-9, system designers can implement diagnostic solutions that are both efficient and non-invasive. These solutions do not require substantial internal hardware modifications or firmware changes to the system under test.

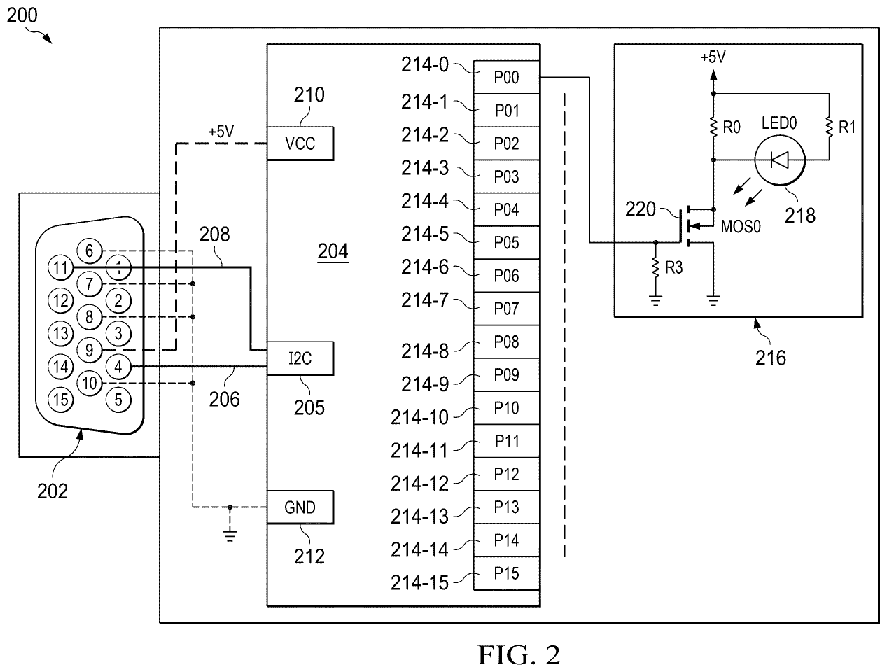

FIG. 2 illustrates an example monitoring device 200 having a D-sub connector 202, in accordance with one or more implementations of the present disclosure. The monitoring device 200 can be configured to interface with a host system through the D-sub connector 202 and to provide real-time diagnostic feedback based on system signals transmitted via the D-sub interface.

The monitoring device 200 includes the D-sub connector 202 and an I/O expansion circuit 204 coupled to the D-sub connector 202. The I/O expansion circuit 204 is operable to receive control signals from the host system and generate output indications in response to those signals, thereby enabling system monitoring through visual or other forms of feedback.

In some implementations, the D-sub connector 202 is implemented in the same or a similar configuration as the D-sub connector 100 previously described with reference to FIGS. 1A and 1B. Accordingly, detailed structural descriptions of the D-sub connector 202 may be omitted for brevity. In one example, the D-sub connector 202 is implemented as a VGA connector and includes a plurality of terminals that correspond to terminals 102-1 through 102-15 of the D-sub connector 100. Among these terminals, a first terminal, such as terminal 102-4, is repurposed to function as a clock terminal, and a second terminal, such as terminal 102-11, is repurposed to function as a data terminal. These terminals can be used to transmit I2C signals from a host system's BMC to the monitoring device 200.

The I/O expansion circuit 204 includes a communication interface 205. In some implementations, the communication interface 205 is an I2C interface configured to receive serialized control signals. The communication interface 205 includes a first signal line 206, configured as a clock line (e.g., SCL), and a second signal line 208, configured as a data line (e.g., SDA). In this example, the clock terminal of the D-sub connector 202 (e.g., terminal 102-4) is coupled to the first signal line 206, and the data terminal (e.g., terminal 102-11) is coupled to the second signal line 208, allowing I2C communication to be established between the host system and the I/O expansion circuit 204.

The D-sub connector 202 further includes a third terminal, such as terminal 102-9, which is configured to provide a DC power supply (e.g., 5V). The I/O expansion circuit 204 includes a corresponding power terminal 210, which is coupled to terminal 102-9 to receive power from the host system. This configuration enables the monitoring device 200 to operate independently without requiring an external power source, thereby facilitating a plug-and-play user experience.

In some implementations, the I/O expansion circuit 204 also includes a fourth terminal 212 configured to provide a ground reference. The fourth terminal 212 can be electrically coupled to one or more ground terminals of the D-sub connector 202, such as terminals 102-6, 102-7, 102-8, and 102-10. This grounding configuration ensures stable voltage levels and reliable signal referencing throughout the device.

The I/O expansion circuit 204 further includes a plurality of I/O terminals configured for general-purpose signal output or input. In the illustrated example, the I/O expansion circuit 204 includes I/O terminals 214-0 through 214-15 (collectively referred to as I/O terminals 214). In some implementations, I/O terminals 214 are General Purpose Input/Output (GPIO) terminals capable of being selectively driven high or low based on received commands. Although fifteen I/O terminals 214 are shown for illustrative purposes, the I/O expansion circuit 204 can include any suitable number of I/O terminals—for example, 8, 16, 24, or more—depending on the number of parameters to be monitored and the specific capabilities of the I/O expansion circuit 204.

In some implementations, one or more of the I/O terminals 214 are coupled to a respective indicator circuit 216, which is operable to provide a visual or other sensory indication based on the signal present at the corresponding terminal. Each I/O terminal 214 can be coupled to a respective indicator circuit 216 to monitor individual signal states. For example, the indicator circuit 216 can include a light-emitting element, such as an LED 218, configured to illuminate when a high signal is output from an I/O terminal 214. The indicator circuit 216 can further include a transistor—such as a MOSFET 220—used to switch current to the LED 218. The gate of the MOSFET 220 is driven by the signal at the I/O terminal 214, allowing the LED 218 to turn on or off in response to system conditions. While FIG. 2 illustrates a single indicator circuit 216 for clarity, it will be understood that multiple indicator circuits 216 can be employed, each associated with a respective I/O terminal 214.

These visual indicators provide real-time feedback on system status, such as component presence, voltage stability, thermal thresholds, or error states, allowing field technicians or developers to quickly assess the condition of the host system without opening the chassis or connecting a laptop. The design is scalable, cost-effective, and compatible with legacy infrastructure, offering a highly practical diagnostic solution.

The use of a VGA-compatible interface that includes repurposed terminals for diagnostic purposes allows diagnostic functionality to be implemented using existing I/O infrastructure, including legacy systems, without requiring substantial modifications to the physical interface. Existing ports on the front panel, such as a VGA connector, can be reused for diagnostic communication, which can reduce the need for additional connectors, breakout headers, or expansion interfaces. In some implementations, a detachable and self-powered diagnostic card can be connected to the VGA-compatible interface to enable system status monitoring without opening the chassis, interrupting system operation, or relying on external software-based diagnostic tools.

The architecture enables system monitoring capabilities to be integrated in a manner that utilizes existing signal lines and available power sources within a commonly implemented connector. In some use cases, this configuration can be applied to improve access to system-level status information while maintaining compatibility with established hardware configurations. The use of an external monitoring device in conjunction with the repurposed connector allows for observability across various system conditions without requiring substantial changes to core system functionality or design.

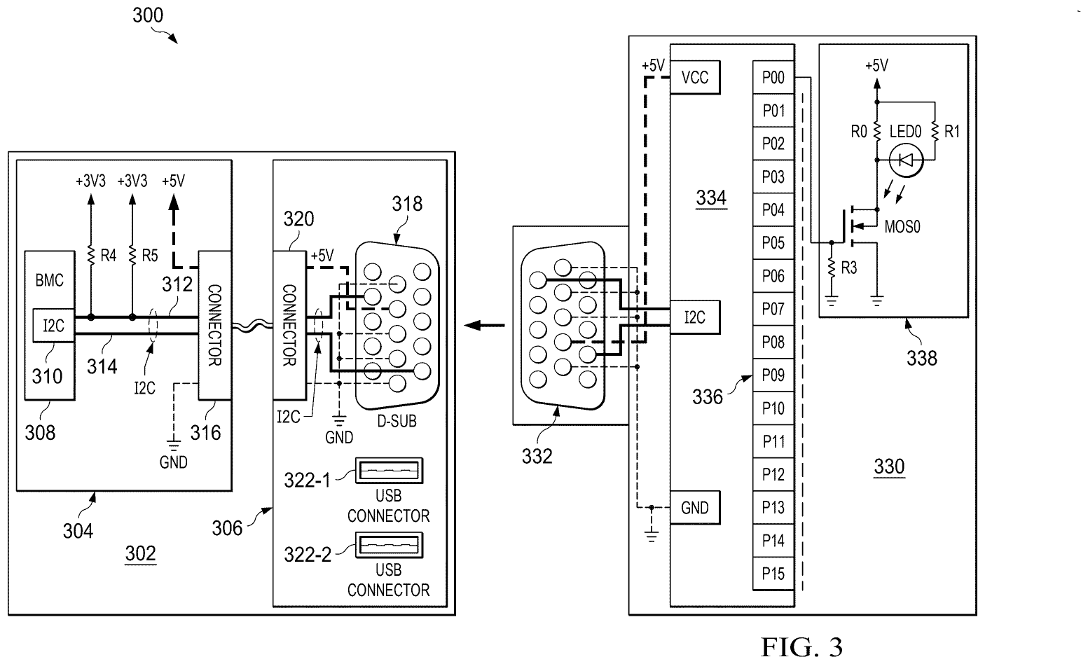

FIG. 3 illustrates an example system 300 that includes a server 302 and a monitoring device 330, in accordance with one or more implementations of the present disclosure. In some implementations, the monitoring device 330 is implemented in the same or a similar configuration as the monitoring device 200 previously described with reference to FIG. 2. Accordingly, detailed structural descriptions of the monitoring device 330 may be omitted for brevity.

The server 302 includes a motherboard 304 and a front control panel 306. In some implementations, the server 302 may also include additional components such as one or more processors, memory modules, power supply units, storage devices, or peripheral interface cards.

The motherboard 304 includes a baseboard management controller (BMC) 308 and a connector 316. The BMC 308 includes an I2C interface 310, which includes a clock line 312 and a data line 314. These signal lines are routed to the connector 316, allowing I2C communication with external components. In some implementations, the connector 316 is a board-to-cable header, a low-profile mezzanine (LPM) connector, or a multi-pin I/O connector used for front-panel signal routing. The connector 316 provides a physical interface through which I2C signals can be transmitted to other parts of the system, such as the front control panel or an external diagnostic module.

The front control panel 306 includes a D-sub connector 318, a connector 320, and USB ports 322-1 and 322-2. In some implementations, the D-sub connector 318 is implemented as a VGA connector, such as the D-sub connector 100 described with reference to FIG. 1. Accordingly, detailed structural descriptions of the D-sub connector 318 may be omitted for brevity. The front control panel 306 may also include additional input/output interfaces, status indicators, or user-facing components not shown in the figure. The D-sub connector 318 includes a plurality of terminals, which in some implementations include a first terminal configured to function as an I2C clock terminal (e.g., terminal 102-4 of the D-sub connector 100) and a second terminal configured to function as an I2C data terminal (e.g., terminal 102-11 of the D-sub connector 100). These terminals are repurposed from their original VGA designations to support auxiliary communication between the BMC 308 and an external monitoring device such as the monitoring device 330.

The connector 320 is electrically coupled to the D-sub connector 318 and provides an internal routing path for signals transmitted from the motherboard. In some implementations, the connector 320 is implemented in the same or a similar configuration as the connector 316.

The connector 316 on the motherboard 304 is coupled to the connector 320 on the front control panel 306 using, for example, a signal cable. The clock line 312 and the data line 314 of the BMC 308 are routed through connector 316, the connecting cable, and connector 320, and are ultimately coupled to the clock and data terminals of the D-sub connector 318. In this manner, the BMC 308 can transmit I2C signals—including both clock and data signals—through the D-sub connector 318, enabling communication with external devices connected via the front panel.

The monitoring device 330 includes a D-sub connector 332 configured to mate with the corresponding D-sub connector 318 on the server 302. The D-sub connector 332 includes a plurality of terminals arranged in a configuration corresponding to the terminals 102 of the D-sub connector 100. Among these terminals, a first terminal (e.g., terminal 102-4) is designated for receiving an I2C clock signal, and a second terminal (e.g., terminal 102-11) is designated for receiving an I2C data signal. These terminals are electrically coupled to the I2C signal lines of the BMC 308 via the front control panel 306, enabling bidirectional communication between the BMC 308 and the monitoring device 330.

To ensure correct electrical mating, the gender of the D-sub connectors 318 and 332 can be complementary. For example, in some implementations, if the D-sub connector 318 on the server 302 is a male connector, then the D-sub connector 332 on the monitoring device 330 is a female connector. Conversely, if the D-sub connector 318 is a female connector, the D-sub connector 332 is a male connector.

The D-sub connector 318 is physically and electrically coupled to the D-sub connector 332 such that corresponding terminals are aligned and connected. For example, terminal 102-4 of the D-sub connector 318 is coupled to terminal 102-4 of the D-sub connector 332, allowing the I2C clock signal to pass through. Similarly, terminal 102-11 of the D-sub connector 318 is aligned with terminal 102-11 of the D-sub connector 332, facilitating data signal transfer. Power and ground terminals (such as terminal 102-9 and terminals 102-6 through 102-8) may also be correspondingly coupled to supply power and ensure signal grounding for the monitoring device.

The monitoring device 330 further includes an I/O expansion circuit 334, which includes an I2C interface to receive and interpret control signals from the BMC 308. The I2C interface includes a first signal line operable as a clock signal line and a second signal line operable as a data signal line.

The clock terminal of the D-sub connector 332 is coupled to the clock signal line of the I2C interface, and the data terminal of the D-sub connector 332 is coupled to the data signal line of the I2C interface, thereby enabling the I/O expansion circuit 334 to receive I2C commands from the host system.

The I/O expansion circuit 334 further includes a plurality of I/O terminals 336 configured for general-purpose input/output functionality. In some implementations, the I/O terminals 336 are GPIO terminals that are capable of being selectively driven to high or low logic levels in response to received I2C signals. FIG. 3 illustrates fifteen I/O terminals 336 for example purposes. However, in some implementations, the I/O expansion circuit 334 may include any suitable number of terminals, such as 8, 16, 24, or more, depending on the number of parameters to be monitored and the specific capabilities of the I/O expansion circuit 334.

In some implementations, one or more of the I/O terminals 336 are coupled to a respective indicator circuit 338. Each indicator circuit 338 is operable to provide a visual or sensory indication—such as an LED illumination—based on the logic state of the corresponding I/O terminal. For example, if a particular system condition is active (e.g., 5V standby power present), the corresponding I/O terminal may output a high signal, triggering the associated LED to illuminate. This allows technicians to assess specific system states at a glance. Each I/O terminal 336 can be individually mapped to a unique status signal—for example, power rail presence (e.g., 12V standby, 5V main), component presence (e.g., CPU or fan detection), or system controller activity (e.g., BMC heartbeat). While FIG. 3 shows one such indicator circuit for illustrative clarity, it is understood that multiple indicator circuits 338 can be present, each corresponding to a different I/O terminal 336. Table 2 provides an example mapping of I/O terminals 336 to monitored system parameters.

TABLE 2

| I/O | | |
|---|---|---|
| ter- | | Description of |
| minal | Function | the function |
| P00 | P12V_STBY_PG = 1, then LED0 is lit; | Motherboard 12 V |
| | P12V_STBY_PG = 0, then LED0 is off. | Standby Power Indicator |
| P01 | P5V_STBY_PG = 1, LED1 is lit; | Motherboard 5 V |
| | P5V_STBY_PG = 0, then LED1 is off. | Standby Power |
| | | Indicator |
| P02 | P3V3_STBY_PG = 1, then LED2 is lit; | Motherboard 3.3 V |
| | P3V3_STBY_PG = 0, then LED2 goes | Standby Power Indicator |
| | out. | |
| P03 | P12V_PG = 1, LED3 is lit; | Motherboard 12 V |
| | P12V_PG = 0, then LED3 is off. | Main Power-On Indicator |
| P04 | P5V_PG = 1, LED4 is lit; | Motherboard 5 V |
| | P5V_PG = 0, then LED4 is off. | Power-On Indicator |
| P05 | P3V_PG = 1, LED5 is lit; | Motherboard 3 V |
| | P3V_PG = 0, then LED5 is off. | Power-On Indicator |
| P06 | PVNN_PCH = 1, then LED6 is lit; | Motherboard |
| | PVNN_PCH = 0, then LED6 is off. | Southbridge VNN |
| | | Power Indicator |
| P07 | PVCCFA_PG = 1, then LED7 is lit; | Motherboard Southbridge |
| | PVCCFAPG = 0, then LED7 is off. | VCCFA Power Indicator |
| P08 | CPU0 is present, LED8 is lit; | CPU0 Presence Indicator |
| | CPU0 is not present, then LED8 is off. | |
| P09 | CPU1 is present, LED9 is lit; | CPU1 Presence Indicator |
| | CPU1 is not present, then LED9 is off. | |
| P10 | FAN0 is present, LED10 is lit; | Fan0 Presence Indicator |
| | FAN0 is not present, then LED10 is off. | |
| P11 | FAN1 is present, LED11 is lit; | Fan1 Presence Indicator |
| | FAN1 is not present, LED11 is off. | |
| P12 | FAN2 is present, LED12 is lit; | Fan2 Presence Indicator |
| | FAN2 is not present, LED12 is off. | |
| P13 | FAN3 is present, LED13 is lit; | Fan3 Presence Indicator |
| | FAN3 is not present, LED13 is off. | |
| P14 | The BMC Health LED is | Motherboard |
| | flashing, LED14 is lit; | Management Chip |
| | The BMC Health LED does not flash, | Breathing Indicator |
| | then LED14 turns off. | |
| P15 | The PCH Health LED is flashing and | Motherboard Southbridge |
| | LED15 is lit; | Breathing Indicator |
| | The PCH Health LED does | |
| | not flash, then LED15 turns off. | |

In some implementations, system monitoring functionality is enabled by leveraging a VGA-compatible D-sub connector to transmit auxiliary signals, such as I2C clock and data lines. This approach repurposes an existing physical interface that is widely adopted in server and computing systems, particularly on front control panels. By utilizing available terminals within the D-sub connector, the need for dedicated diagnostic headers, additional communication ports, or modifications to the motherboard layout is reduced or eliminated, facilitating integration with minimal changes to existing hardware designs.

The inclusion of a detachable, self-powered monitoring device—such as the monitoring device 330—supports convenient integration and operation. The monitoring device 330 can be connected to the server 302's front control panel 306 without requiring system shutdown or removal of the chassis enclosure, thereby allowing diagnostic operations to be performed during active system states. This configuration can be beneficial in environments such as field diagnostics, hardware validation, and service workflows.

The I/O expansion circuit 334 within the monitoring device 330 is scalable in terms of I/O terminal count and functional capacity. Depending on system requirements, a limited number of GPIO terminals can be used to monitor essential power rails or signal presence, while expanded configurations can include higher-density I/O expanders to support broader monitoring coverage. Examples of monitored parameters include voltage and power rail availability, thermal sensor states, fan and processor presence, and control chip activity indicators.

By repurposing select terminals within a standardized connector format, the disclosed architecture facilitates enhanced system observability while maintaining compatibility with existing hardware designs. The modular and non-intrusive nature of the system allows for cost-effective integration across various computing environments, including legacy server platforms, embedded control systems, and hardware development platforms.

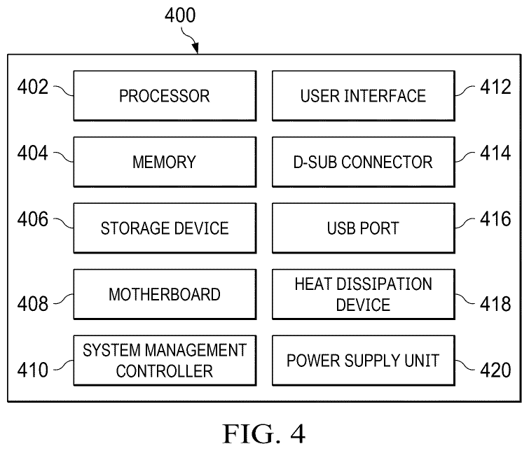

FIG. 4 illustrates an example computer system 400, in accordance with one or more implementations of the present disclosure. In some examples, the computer system 400 can be implemented as the server 302 described in previous implementations. The computer system 400 can be representative of a server, data center node, embedded controller, or other computing platform configured to support hardware-level monitoring and system management functionality.

The computer system 400 includes one or more processors 402 that are configured to execute software programs, manage computational resources, and coordinate the operation of various system components. The processors 402 can be implemented as single-core, multi-core, or multi-socket processor architectures depending on the system's performance requirements. In some implementations, the processors 402 support virtualization, parallel processing, or specialized system management instructions.

The one or more memories 404 provide volatile storage to support active software execution and fast data access. For example, the memories 404 can include dynamic random-access memory (DRAM) modules that store system state, execution context, or frequently accessed data structures for the processors 402.

The one or more storage devices 406 provide non-volatile storage for long-term data retention. These storage components can include solid-state drives (SSDs), hard disk drives (HDDs), or hybrid storage configurations. In some examples, the storage 406 can contain firmware, logs, boot images, or archival data used for operational recovery or diagnostic analysis.

The computer system 400 further includes a motherboard 408, which serves as the central printed circuit board (PCB) interconnecting the primary system components. The motherboard 408 can include the physical and electrical infrastructure for processors, memories, expansion slots, onboard controllers, and interface connectors. In some implementations, the motherboard 408 includes one or more embedded buses (e.g., PCIe, I2C, Serial Peripheral Interface (SPI)) for internal communication, as well as power distribution layers for regulated voltage delivery to various subsystems.

The computer system 400 further includes a system management controller 410, which can be implemented as a BMC integrated on the motherboard 408. The system management controller 410 is configured to monitor and manage system health, power states, sensor data, and remote access functions independent of the host operating system. The system management controller 410 can include a dedicated microcontroller and firmware to support protocols such as I2C, Intelligent Platform Management Interface (IPMI), Redfish, or SMBus. For example, the system management controller 410 can collect data from thermal sensors, voltage monitors, fan tachometers, or component presence signals, and expose this information to administrators through an out-of-band management interface.

The user interface 412 provides an access point for system administrators or operators to interact with the computer system 400. In some implementations, the user interface 412 include a graphical user interface (GUI) displayed via a connected monitor, a command-line interface (CLI) accessible through a serial or SSH session, or a web-based management dashboard. The user interface 412 can enable users to view real-time system status, configure firmware settings, access error logs, and perform remote diagnostics or control functions.

The computer system 400 further includes one or more D-sub connectors 414. The D-sub connectors 414 can include standard configurations such as the DE-15 VGA connector and can be mounted on the front or rear panel of the chassis. In some implementations, one or more terminals within the D-sub connectors 414 are repurposed to transmit auxiliary signals—such as I2C clock and data lines—from the system management controller 410. This enables the D-sub connector 414 to support both its conventional video output function and additional diagnostic or monitoring capabilities when coupled to an external monitoring device.

The computer system 400 also includes one or more USB ports 416, which can be used for peripheral connectivity, firmware updates, or console redirection. These ports may support USB 2.0, USB 3.x, or later protocols and may be located alongside the D-sub connectors on the front control panel for technician access.

The computer system 400 further includes one or more heat dissipation devices 418, which can include active or passive cooling components. In some implementations, the heat dissipation devices 418 include axial or centrifugal fans positioned to draw airflow across high-temperature zones, or liquid cooling components such as pumps, tubes, and radiators to manage thermal output from processors and memory modules.

The computer system 400 further includes one or more power supply units (PSUs) 420 that are configured to supply regulated electrical power to the system components. In some implementations, the PSUs 420 include multiple voltage rails (e.g., 12V, 5V, 3.3V), power conditioning circuits, and protection mechanisms. In some implementations, the PSUs 420 support features such as redundancy, hot-swap capability, or uninterruptible power supply (UPS) integration. The PSUs 420 can also provide power to external devices through interfaces such as the D-sub connectors 414, enabling plug-and-play operation of attached monitoring hardware.

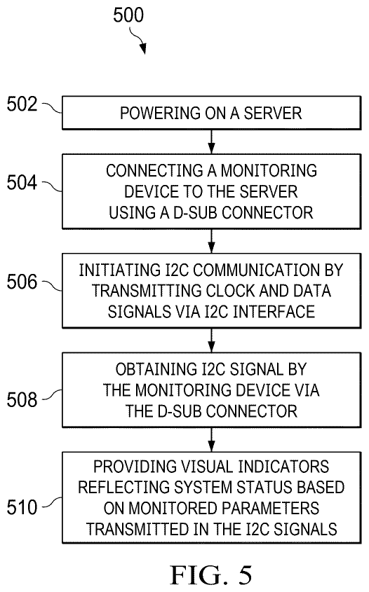

FIG. 5 is a flowchart illustrating an example method 500, in accordance with one or more implementations of the present disclosure. The method 500 can be performed by any suitable computing system or monitoring configuration as described herein, including, for example, the system 300. For illustrative purposes, the steps of method 500 are described below with reference to components of system 300.

At 502, the server 302 included in system 300 is powered on. As shown in FIG. 3, the server 302 includes a motherboard 304 that houses various subsystems, including a processor, memory modules, and peripheral interfaces. Upon power-up, the baseboard management controller (BMC) 308 becomes operational. The BMC 308 is responsible for monitoring system status, including power rail presence (e.g., 12-volt standby, 5-volt standby), thermal conditions, and the presence of components such as fans and CPUs. The BMC 308 includes an I2C interface 310 that generates two communication lines: a clock line 312 and a data line 314. These lines are used for transmitting system health and control signals to external monitoring components. This initialization forms the basis for downstream diagnostic communication through the D-sub interface.

At 504, a monitoring device 330 is connected to the server 302 using a D-sub connector interface. As illustrated in FIG. 3, the front control panel 306 of the server 302 includes a D-sub connector 318, which can be implemented as a VGA-compatible DE-15 connector as shown in FIG. 1A. The D-sub connector 318 is internally coupled to the motherboard 304 through connectors 316 and 320 and a signal cable. The monitoring device 330 includes a corresponding D-sub connector 332 that mates with connector 318. As shown in FIG. 1B, specific terminals of the D-sub connector, such as terminal 102-4 and terminal 102-11, are repurposed to carry I2C clock and data signals, respectively. Terminal 102-9 may provide a 5V power supply to the connected monitoring device. When the monitoring device 330 is connected, corresponding terminals are electrically coupled to form a complete I2C communication pathway between the BMC 308 and the monitoring device 330.

At 506, the BMC 308 initiates I2C communication by transmitting clock and data signals via its I2C interface 310. The clock line 312 and data line 314 are routed to connector 316 on the motherboard 304, passed through connector 320 on the front control panel 306, and finally directed to specific terminals on the D-sub connector 318. In the example shown in FIG. 1B, terminal 102-4 is used for the I2C clock signal and terminal 102-11 is used for the data signal. These signals are transmitted through the mated D-sub interface when the monitoring device 330 is connected, allowing external access to real-time system information from the BMC. Power from terminal 102-9 may also be used to supply energy to the connected monitoring device.

At 508, the monitoring device 330 obtains the transmitted I2C signals through its D-sub connector 332. As shown in FIG. 2 and FIG. 3, the D-sub connector 332 includes terminals corresponding to those on connector 318. The I2C clock and data signals are routed from connector 332 to an I/O expansion circuit 334 within the monitoring device. The I/O expansion circuit 334 includes an I2C communication interface configured to interpret the received signals. In some implementations, the monitoring device 330 is powered directly via the 5V supply line from the D-sub connector 332, eliminating the need for additional cabling or external power sources. The physical connection and electrical compatibility between D-sub connectors 318 and 332 enable seamless data transfer to the monitoring device using standard front panel infrastructure.

At 510, the monitoring device 330 provides one or more visual indicators reflecting system status based on monitored parameters transmitted in the I2C signals. As shown in FIG. 2, the I/O expansion circuit 204 (or 334 in FIG. 3) includes a plurality of GPIO terminals 214 (or 336). Each GPIO terminal can be coupled to an indicator circuit 216 (or 338), which includes an LED 218 and a transistor, such as a MOSFET 220. The BMC 308 can address individual GPIO outputs through I2C commands, enabling or disabling specific LEDs based on the monitored parameters. Each indicator can correspond to a specific system state, such as the presence of power rails (e.g., 12V standby power), component detection (e.g., CPU or fan), or heartbeat signals from system controllers (e.g., the BMC or southbridge). The result is a set of immediately observable status indicators that can assist technicians in diagnosing system conditions without removing the chassis or relying on external diagnostic software.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a standalone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer readable media for storing computer program instructions and data can include all forms of permanent/non-permanent or volatile/non-volatile memory, media and memory devices, including by way of example semiconductor memory devices, for example, random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto optical disks; and optical memory devices, for example, digital versatile/video disc (DVD), compact disc (CD) ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back end, middleware, or front end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation may be applicable to a computer-implemented method; a non-transitory, computer-readable medium storing computer-readable instructions to perform the computer-implemented method; and/or a computer system comprising a computer memory interoperably coupled with a hardware processor configured to perform the computer-implemented method or the instructions stored on the non-transitory, computer-readable medium.

What is claimed is:

1. A monitoring device, comprising:
a D-sub connector, wherein the D-sub connector comprises a plurality of terminals, the plurality of terminals comprise a first terminal operable as a clock terminal and a second terminal operable as a data terminal; and
an input/output (I/O) expansion circuit, wherein the I/O expansion circuit comprises a communication interface, the communication interface comprises a first signal line and a second signal line;
wherein the first terminal of the D-sub connector is coupled to the first signal line of the I/O expansion circuit, and the second terminal of the D-sub connector is coupled to the second signal line of the I/O expansion circuit.

2. The monitoring device of claim 1, wherein the D-sub connector comprises a Video Graphics Array (VGA) connector.

3. The monitoring device of claim 1, wherein the communication interface comprises an inter-integrated circuit (I2C) communication interface.

4. The monitoring device of claim 1, wherein the first signal line of the communication interface is a clock line, and the second signal line of the communication interface is a data line.

5. The monitoring device of claim 1, wherein the D-sub connector further comprises a third terminal, the I/O expansion circuit further comprises a power terminal, and the third terminal of the D-sub connector is coupled to the power terminal of the I/O expansion circuit.

6. The monitoring device of claim 1, wherein the I/O expansion circuit further comprises a plurality of input/output (I/O) terminals.

7. The monitoring device of claim 6, wherein the plurality of I/O terminals are General Purpose Input/Output (GPIO) terminals.

8. The monitoring device of claim 6, wherein at least one I/O terminal of the plurality of I/O terminals is coupled to an indicator operable to provide an indication based on a signal present at the at least one I/O terminal.

9. The monitoring device of claim 8, wherein the indicator comprises a light-emitting element.

10. A system, comprising:
a server comprising a first D-sub connector; and
a monitoring device comprising:
a second D-sub connector operable to be coupled to the first D-sub connector of the server, wherein the second D-sub connector comprises a plurality of terminals, the plurality of terminals comprise a first terminal operable as a clock terminal and a second terminal operable as a data terminal; and
an input/output (I/O) expansion circuit, wherein the I/O expansion circuit comprises a communication interface, the communication interface comprises a first signal line and a second signal line;
wherein the first terminal of the second D-sub connector is coupled to the first signal line of the I/O expansion circuit, and the second terminal of the second D-sub connector is coupled to the second signal line of the I/O expansion circuit.

11. The system of claim 10, wherein the first D-sub connector of the server comprises a first terminal operable as a clock terminal and a second terminal operable as a data terminal.

12. The system of claim 11, wherein the server further comprises a system management controller, the system management controller comprises a communication interface comprising a clock line coupled to the first terminal of the first D-sub connector and a data line coupled to the second terminal of the first D-sub connector.

13. The system of claim 11, wherein the first terminal of the first D-sub connector is operable to be coupled to the first terminal of the second D-sub connector, and the second terminal of the first D-sub connector is operable to be coupled to the second terminal of the second D-sub connector.

14. The system of claim 11, wherein each of the first D-sub connector and the second D-sub connector comprises a Video Graphics Array (VGA) connector.

15. The system of claim 11, wherein the communication interface comprises an inter-integrated circuit (I2C) communication interface.

16. The system of claim 11, wherein the I/O expansion circuit further comprises a plurality of input/output (I/O) terminals.

17. The system of claim 16, wherein the plurality of I/O terminals are General Purpose Input/Output (GPIO) terminals.

18. The system of claim 17, wherein at least one I/O terminal of the plurality of I/O terminals is coupled to an indicator operable to provide an indication based on a signal present at the at least one I/O terminal.

19. The system of claim 18, wherein the indicator comprises a light-emitting element.

20. A monitoring device, comprising:
a D-sub connector, wherein the D-sub connector comprises a plurality of terminals, the plurality of terminals comprise a first terminal operable as a clock terminal and a second terminal operable as a data terminal; and
an input/output (I/O) expansion circuit, wherein the I/O expansion circuit comprises a communication interface, the communication interface comprises a first signal line and a second signal line, wherein the first terminal of the D-sub connector is coupled to the first signal line of the I/O expansion circuit, and the second terminal of the D-sub connector is coupled to the second signal line of the I/O expansion circuit;
wherein the I/O expansion circuit further comprises a plurality of input/output (I/O) terminals, and each of the plurality of I/O terminal is coupled to an indicator operable to provide an indication based on a signal present at the corresponding I/O terminal.
